(19) United States
(12) Patent Application Publication
(10) Pub. No.: US 2020/0033629 A1
(43) Pub. Date: Jan. 30, 2020

(54) NOSE PAD AND EYEGLASSES

(71) Applicant: Masakatsu Naya, Aichi-ken (JP)

(72) Inventor: Masakatsu Naya, Aichi-ken (JP)

(21) Appl. No.: 16/525,779

(22) Filed: Jul. 30, 2019

(30) Foreign Application Priority Data
Jul. 30, 2018 (JP) 2018142660

(51) Int. Cl. G02C 5/12

(52) U.S. Cl. CPC G02C 5/12

(57) ABSTRACT

A nose pad for eyeglasses configured to be attached to a front frame of the eyeglasses may include a pad body, an extended portion formed on an upper portion of the pad body and configured to extend toward the front frame of the eyeglasses when the nose pad is attached to the front frame, and an anti-slipping member formed on the extended portion.

### CROSS-REFERENCE TO RELATED APPLICATIONS

This application claims priority to Japanese patent application number 2018-142660 filed Jul. 30, 2018, the contents of which are incorporated herein by reference in their entirety for all purposes.

### BACKGROUND

The present disclosure relates to a nose pad and eyeglasses having a nose pad.

Generally, eyeglasses are composed of a pair of rims connected to each other by a bridge and having lenses fitted therein, a pair of temples pivotally connected to the rims, and a pair of nose pads attached to the rims via nose pad arms (clings). As will be recognized, when a user uses (wears) the eyeglasses, the temples are put on ears of the user while the nose pads are brought into contact with a nose of the user.

Further, when the eyeglasses become temporarily unnecessary for the user, the user may often displace the eyeglasses upward until the nose pads of the eyeglasses contact a forehead of the user (i.e., a body region other than the nose), instead of completely removing the eyeglasses. As a result, the eyeglasses may be placed on the forehead of the user. However, the nose pads of the eyeglasses may easily slide down along the forehead of the user because of their low friction coefficient. Therefore, the eyeglasses may easily fall down from the forehead of the user unexpectedly.

Further, eyeglasses having specially designed nose pads is known. Such known eyeglasses are taught, for example, by Japanese Laid-Open Patent Publication No. 9-146053 (JP9-146053A). In the eyeglasses, each of the nose pads is covered with a sponge material having high coefficient of friction. As a result, the nose pads may generate an increased frictional force against the forehead of the user when the eyeglasses are placed on the forehead of the user. Therefore, according to the eyeglasses having the nose pads thus treated, when the eyeglasses are placed on the forehead of the user, the eyeglasses may be reliably held thereon, so as to be effectively prevented from falling away therefrom due to the increased frictional force of the nose pads against the forehead.

However, in the known eyeglasses having such nose pads, when the user uses (wears) the eyeglasses, the sponge material having the high coefficient of friction may contact the nose of the user because each of the nose pads is completely covered with the sponge material. Therefore, the eyeglasses may lead to discomfort.

Thus, there is a need in the art for an improved nose pad and eyeglasses having such an improved nose pad.

### SUMMARY

In one aspect of the present disclosure, a nose pad for eyeglasses configured to be attached to a front frame of the eyeglasses may include a pad body, an extended portion formed on an upper portion of the pad body and configured to extend toward the front frame of the eyeglasses when the nose pad is attached to the front frame, and an anti-slipping member formed on the extended portion.

According to the aspect, when the front frame of the eyeglasses to which the nose pad is attached is lifted up to displace the eyeglasses upward (i.e., when the eyeglasses are not being used), the anti-slipping member formed on the extended portion of the pad body may contact, for example, a skin of a forehead of a user. At this time, the anti-slipping member may generate a frictional force against the skin of the forehead of the user. As a result, the eyeglasses (the front frame) may be reliably held on the forehead of the user due to the frictional force of the anti-slipping member against the skin of the forehead of the user. That is, the eyeglasses may be effectively prevented from falling away from the forehead of the user. Further, the extended portion of the pad body on which the anti-slipping member is formed may extend forward toward the front frame. Therefore, the anti-slipping member does not prevent the front frame of the eyeglasses from being lifted up. In addition, during normal use of the eyeglasses, the pad body of the nose pad may contact a nose of the user whereas the anti-slipping member formed on the extended portion of the pad body may be spaced away from the nose of the user. Therefore, the user may use the eyeglasses without any feeling of discomfort from the anti-slipping member.

Other objects, features and advantage of the present disclosure will be readily understood after reading the following detailed description together with the accompanying drawings and the claims.

### BRIEF DESCRIPTION OF THE DRAWINGS

FIG. 1 is an elevational view of a pair of right and left nose pads according to a first representative embodiment of the disclosure.

FIG. 2 is a rear elevational view of the right and left nose pads.

FIG. 3 is a side view of the left nose pad.

FIG. 4 is a cross-sectional view taken along line IV-IV in FIG. 1.

FIG. 5 is a side view of eyeglasses having the nose pads, which view shows a condition in which a user wears the eyeglasses.

FIG. 6 is an enlarged view of a portion VI in FIG. 5.

FIG. 7 is a side view of one of a pair of right and left nose pads according to a modified embodiment.

FIG. 8 is a side view of one of a pair of right and left nose pads according to a modified embodiment.

FIG. 9 is a perspective view of eyeglasses having right and left nose pads according to a second representative embodiment of the disclosure.

### DETAILED DESCRIPTION

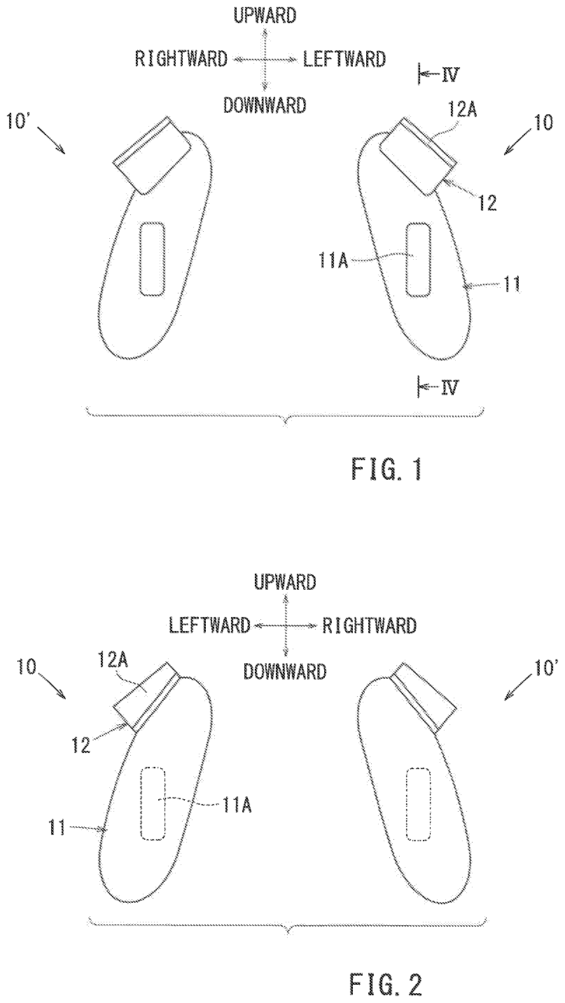

Representative embodiments will now be described in detail with reference to FIGS. 1 to 9.

Below, a pair of right and left nose pads 10 and 10′ according to a first embodiment of this disclosure and eyeglasses 20 having the nose pads 10 and 10′ will be described with reference to FIGS. 1 to 6. Further, forward, backward, rightward, leftward, upward and downward directions described with reference to the figures may respectively correspond to forward, backward, rightward, leftward, upward and downward directions of the eyeglasses 20 or a user 90 using (wearing) the eyeglasses 20.

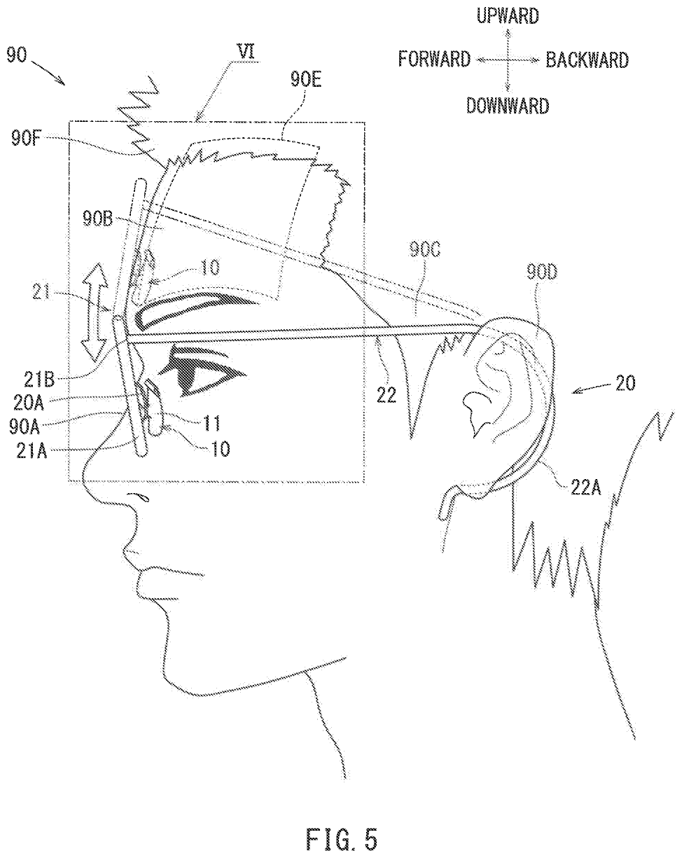

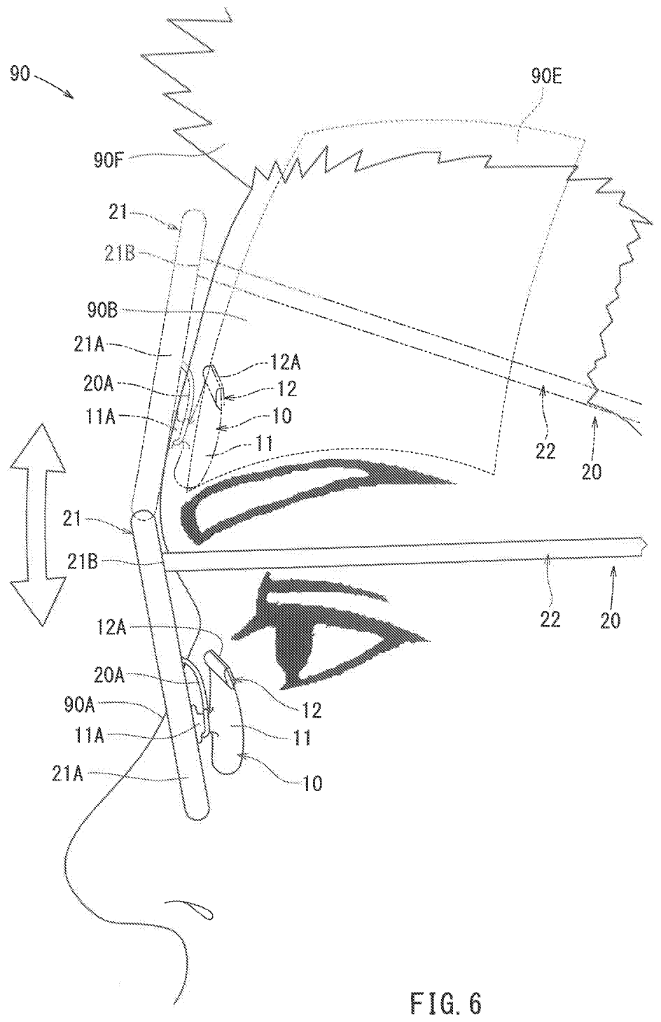

First, constructions of the eyeglasses 20 to which nose pads 10 and 10′ are attached will be described. As shown in FIGS. 5 and 6, the eyeglasses 20 may be essentially composed of a front frame 21, a pair of temples 22 (one of which is shown), and lenses (not shown). The front frame 21 may be composed of a pair of rims 21A (one of which is shown) in which the lenses are respectively fitted and a bridge (not shown). The rims 21A may be connected to each other by the bridge so as to form the front frame 21. Further, the front frame 21 (the rims 21A connected to each other) may have closing or connecting blocks 21B (one of which is shown) respectively formed on right and left sides thereof. The temples 22 may respectively be pivotally connected to the connecting blocks 21B of the front frame 21 via hinge mechanisms (not shown). Therefore, the temples 22 may be pivoted between a folded condition (not shown) in which they are folded relative to the front frame 21 and a spread condition (FIGS. 5 and 6) in which they are spread relative to the front frame 21.

As shown in FIGS. 5 and 6, the temples 22 may respectively have temple tips 22A formed at distal (rear) ends thereof and configured to be put on and/or around ears (auricles) 90D of the user 90 from above. Further, the temple tips 22A may be formed into a semicircular shape. That is, the temples 22 may be formed as anatomic side-type temples.

As shown in FIGS. 5 and 6, the nose pads 10 and 10′ may respectively be attached to the rims 21A (the front frame 21) via nose pad arms (clings) 20A (one of which is shown) connected to the rims 21A and having nose pad attaching rings (not shown) formed thereon, which will be hereinafter described in detail.

When the user 90 uses (wears) the eyeglasses 20 (i.e., when the eyeglasses 20 are used), the temples 22 may be pivotally spread and then be positioned along temporal regions 90C of the user 90, so that the temple tips 22A formed thereon are put on the ears 90D of the user 90 from above. At this time, the nose pad arms 20A may be positioned along a nose 90A of the user 90, so that the nose pads 10 and 10′ contact the nose 90A of the user 90 (shown by solid lines in FIGS. 5 and 6). In this condition, the eyeglasses 20 may be supported by the temples 22 and the nose pad arms 20A (the nose pads 10 and 10′). Further, the eyeglasses 20 may be configured such that the front frame 21 may be inclined forward when the eyeglasses 20 are being used.

Next, specific constructions of the left nose pad 10 and the right nose pad 10′ will be described in detail. As shown in FIGS. 1 and 2, the left nose pad 10 and the right nose pad 10′ may have the substantially same construction as each other provided that they are formed symmetrically. Therefore, in the following, only the left nose pad 10 will be described as a representative of the left nose pad 10 and the right nose pad 10′ and a description of the right nose pad 10′ may be omitted for brevity.

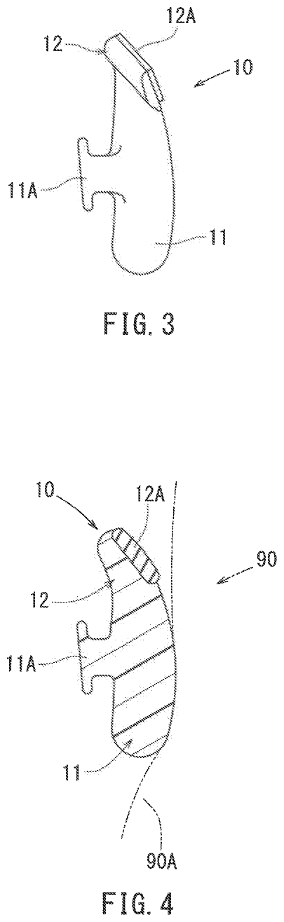

As shown in FIGS. 1 to 4, the (left) nose pad 10 may have a pad body 11 made of resins, silicone or other various materials and configured to directly contact the nose 90A of the user 90 when the eyeglasses 20 are in active use. Further, the nose pad 10 may have an engagement strip 11A formed on and projected forward from a front surface (a left surface in FIG. 3) of the pad body 11. The engagement strip 11A may be configured to engage the nose pad attaching ring formed on the nose pad arm 20A, so that the nose pad 10 (the pad body 11) can be connected to the nose pad arm 20A via the engagement strip 11A. Thus, the nose pad 10 (the pad body 11) can be attached to the rim 21A via the nose pad arm 20A. Further, the pad body 11 may preferably have a smooth (low friction) nose contact surface so as to not generate a sense of discomfort in the nose 90A of the user 90 when the eyeglasses 20 are being used.

As shown in FIGS. 1 to 4, the pad body 11 may have an extended portion 12 formed on an upper portion thereof, i.e., a portion that is directed upward when the eyeglasses 20 are being used. The extended portion 12 may be bent (curved) and extend forward in the substantially same direction as the engagement strip 11A. In particular, the extended portion 12 may be bent and extend forward toward the front frame 21, i.e., toward the nose pad arm 20A to which the nose pad 10 is connected. That is, the extended portion 12 may be configured to extend in a direction away from the nose 90A of the user 90 when the eyeglasses 20 are in use (solid lines in FIGS. 5 and 6).

As shown in FIGS. 1 to 4, the pad body 11 may have an anti-slipping member 12A applied or adhered to a back surface of the extended portion 12. The anti-slipping member 12A may preferably be a sheet-like member made of a material different from the extended portion 12, e.g., a rubber or other suitable material. The anti-slipping member 12A may be configured such that a frictional force thereof against a body surface (skin) of the user 90 is greater than a frictional force of the pad body 11 against the body surface of the user 90. Further, the back surface of the extended portion 12 to which the anti-slipping member 12A is adhered may be an opposite surface (which may be referred to as a second surface) of a surface (which may be referred to as a first surface) facing the nose pad arm 20A (the front frame 21) to which the nose pad 10 is connected. In other words, the back surface of the extended portion 12 may be a surface that faces the nose 90A of the user 90 when the eyeglasses 20 are being used.

Further, as shown in FIGS. 5 and 6, the body surface of the user 90 against which the anti-slipping member 12A generates a frictional force may generally be a skin covering a frontalis muscle 90E of the user 90, i.e., a skin of a forehead 90B of the user 90 in which hair follicles of head hair 90F are not found. However, the body surface of the user 90 may sometimes be the head hair 90F of the user 90.

The (left) nose pad 10 thus constructed may be connected to the nose pad arm 20A by inserting the engagement strip 11A formed on the pad body 11 into the nose pad attaching ring formed on the nose pad arm 20A. As a result, the nose pad 10 may be attached to the rim 21A (the front arm 21) via the nose pad arm 20A. Similarly, the (right) nose pad 10′ may be attached to the rim 21A (the front arm 21) via the nose pad arm 20A. Thus, the eyeglasses 20 having the nose pads 10 and 10′ may be formed or assembled.

As shown in FIGS. 5 and 6, according to the eyeglasses 20 thus formed, when the eyeglasses 20 are in use (shown by solid lines), the temple tips 22A formed on the temples 22 may be put on the ears 90D of the user 90 while the substantial portion of the pad body 11 of the nose pad 10 may contact the nose 90A of the user 90 (shown by solid lines in FIGS. 5 and 6). However, in this condition, the anti-slipping member 12A adhered to the extended portion 12 of the pad body 11 may be spaced from the nose 90A of the user 90 because the extended portion 12 is bent toward the front frame 21. Therefore, the user 90 may use the eyeglasses 20 without any feeling of discomfort.

Conversely, when the eyeglasses 20 become temporarily unnecessary for the user 90, the front frame 21 of the eyeglasses 20 may be lifted up by the user 90, so that the eyeglasses 20 may be rotated upward about the ears 90D of the user 90 on which the temple tips 22A of the temples 22 are put. As a result, the eyeglasses 20 (the front frame 21) are displaced upward, so that some portions of the pad body 11 of the nose pad 10 and the anti-slipping member 12A adhered to the extended portion 12 of the pad body 11 may contact the forehead 90B of the user 90 (i.e., a body region other than the nose 90A). At this time, the anti-slipping member 12A may generate the frictional force against the skin of the forehead 90B of the user 90. As a result, the eyeglasses 20 may be reliably held on the forehead 90B of the user 90 due to the frictional force of the anti-slipping member 12A against the skin of the forehead 90B of the user 90 (shown by chain double-dashed lines in FIGS. 5 and 6). That is, the eyeglasses 20 may be effectively prevented from falling away from the forehead 90B of the user 90. Further, because the extended portion 12 of the pad body 11 to which the anti-slipping member 12A is adhered is bent forward toward the front frame 21, the anti-slipping member 12A does not prevent the eyeglasses 20 from rotating upward about the ears 90D of the user 90 when the front frame 21 of the eyeglasses 20 is lifted up.

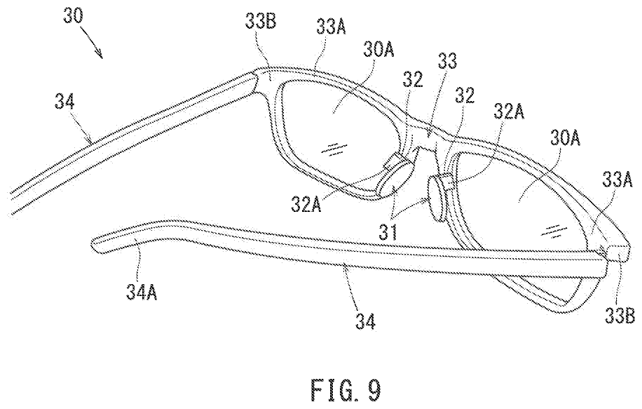

Next, a pair of right and left nose pads (not labeled) according to a second embodiment of this disclosure and eyeglasses 30 having the nose pads will be described with reference to FIG. 9. Further, with regard to elements that are the substantially same in the first and second embodiments, a detailed description of such elements will be omitted.

First, constructions of the eyeglasses 30 will be described. The eyeglasses 30 may be essentially composed of an integrally formed front frame 33, a pair of temples 34, and a pair of lenses 30A. The front frame 33 may be composed of a pair of rims 33A in which the lenses 30A are fitted and a bridge (not labeled) by which the rims 33A are connected to each other. Further, the front frame 33 (the connected rims 33A) may have connecting blocks 33B respectively formed on right and left sides thereof. The temples 34 may respectively be pivotally connected to the connecting blocks 33B of the rims 33A via hinge mechanisms (not shown), so as to be pivoted between a folded condition (not shown) in which they are folded relative to the front frame 33 and a spread condition (FIG. 9) in which they are spread relative to the front frame 33.

The temples 34 may respectively have temple tips 34A formed at distal (rear) ends thereof and configured to be put on and/or around the ears (auricles) of a user from above. Further, the temple tips 34A may be obtusely bent. That is, the temples 34 may be formed as drop end-side type temples.

The nose pads may respectively be attached to the rims 33A via nose pad arms (not shown) connected to the rims 33A in the substantially same manner as the first embodiment.

The eyeglasses 30 thus constructed may be used in the substantially same manner as the eyeglasses 20 of the first embodiment.

Next, specific constructions of the right and left nose pads, which correspond to the nose pads 10 and 10′ of the first embodiment, will be described. As shown in FIG. 9, the right and left nose pads may have the substantially same construction as each other provided that they are formed symmetrically. Therefore, in the following, only the left nose pad will be described as a representative of the right and left nose pads and a description of the right nose pad may be omitted for the sake of brevity.

The nose pad may have a pad body 31 made of various resins, silicone or other various materials. The pad body 31 may have an extended portion 32 formed on an upper portion thereof and extending forward toward the front frame 33 (the rims 33A). Further, the pad body 31 may have an anti-slipping member 32A applied or adhered to a back surface of the extended portion 32. Similar to the anti-slipping member 12A of the first embodiment, the anti-slipping member 32A may preferably be a sheet-like member made of a rubber or similar material, although other shapes and materials may be used.

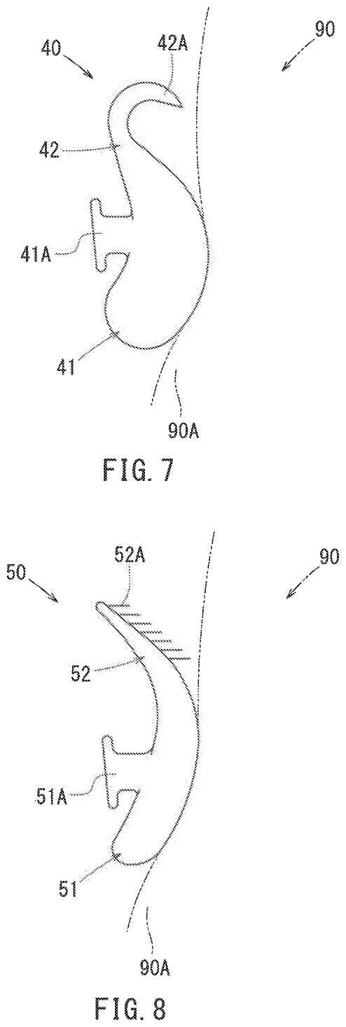

Various changes and modifications may be made to the first and second embodiments without departing from the scope of the disclosure. For example, the nose pad 10 may be replaced with a nose pad 40 shown in FIG. 7. Similar to the nose pad 10, the nose pad 40 may have a pad body 41 configured to directly contact the nose 90A of the user 90 when the eyeglasses 20 are being used. The pad body 41 may have the substantially same structure as the pad body 11 of the nose pad 10. Further, similar to the nose pad 10, the nose pad 40 may have an engagement strip 41A with a similar structure as the engagement strip 11A of the nose pad 10.

Similar to the pad body 11, the pad body 41 may have an extended portion 42 corresponding to the extended portion 12 of the pad body 11. The extended portion 42 may have an anti-slipping member 42A. Unlike the anti-slipping member 12A, the anti-slipping member 42A may be formed as a projection having a hook or claw shape. The anti-slipping member 42A may be curved backward, i.e., in a direction away from the front frame 21 of the eyeglasses 20 to which the nose pad 40 is attached. In other words, the anti-slipping member 42A may be inclined in a direction from a distal end of the extended portion 42 toward the pad body 41. As shown in FIG. 7, the anti-slipping member 42A may be integrally formed on a distal end of the extended portion 42. That is, the anti-slipping member 42A may be formed as a portion of the extended portion 42 (the pad body 41).

Further, the anti-slipping member 42A may be separately formed and connected to the extended portion 42 as necessary. Optionally, the anti-slipping member 42A may be covered or coated with rubber as necessary.

The anti-slipping member 42A may have the same function as the anti-slipping member 12A. That is, similar to the anti-slipping member 12A, when the eyeglasses 20 are rotated and displaced upward, the anti-slipping member 42A may generate the frictional force against the skin of the forehead 90B of the user 90, so that the eyeglasses 20 may be reliably held on the forehead 90B of the user 90. That is, the eyeglasses 20 may be effectively prevented from falling away from the forehead 90B of the user 90. Further, similar to the anti-slipping member 12A, the anti-slipping member 42A does not prevent the eyeglasses 20 from rotating upward about the ears 90D of the user 90 when the front frame 21 of the eyeglasses 20 is lifted up.

Also, the nose pad 10 may be replaced with a nose pad 50 shown in FIG. 8. Similar to the nose pad 10, the nose pad 50 may have a pad body 51 configured to directly contact the nose 90A of the user 90 when the eyeglasses 20 are being used. The pad body 51 may have the substantially same structure as the pad body 11 of the nose pad 10. Further, similar to the nose pad 10, the nose pad 50 may have an engagement strip 51A corresponding to the engagement strip 11A of the nose pad 10.

Similar to the pad body 11, the pad body 51 may have an extended portion 52 corresponding to the extended portion 12 of the pad body 11. The extended portion 52 may have an anti-slipping member 52A. Unlike the anti-slipping member 12A, the anti-slipping member 52A may be formed as a plurality of projections that are directly formed on a back surface of the extended portion 52 and are inclined in a direction toward the pad body 51. The anti-slipping member 52A may preferably be formed by processing the back surface of the extended portion 52. However, the anti-slipping member 52A may be formed as a separate member having a plurality of projections and attached to the back surface of the extended portion 52. Further, the back surface of the extended portion 52 on which the anti-slipping member 52A is formed may be an opposite surface (which may be referred to as a second surface) of a surface (which may be referred to as a second surface) facing the nose pad arm 20A (the front frame 21) to which the nose pad 50 is connected.

The anti-slipping member 52A may have the same function as the anti-slipping member 12A. That is, similar to the anti-slipping member 12A, when the eyeglass 20 is rotated and displaced upward, the anti-slipping member 52A may generate the frictional force against the skin of the forehead 90B of the user 90, so that the eyeglasses 20 may be reliably held on the forehead 90B of the user 90. Further, similar to the anti-slipping member 12A, the anti-slipping member 52A does not prevent the eyeglasses 20 from rotating upward about the ears 90D of the user 90 when the front frame 21 of the eyeglasses 20 is lifted up.

Further, a fish skin having scales (projections) may be used as the separately formed anti-slipping member 52A, i.e., the separate member having the plurality of projections. Generally, the fish skin having scales may have a large frictional resistance in one direction and a small frictional resistance in an opposite direction. Therefore, according to the nose pad 50 in which the fish skin having scales is used as the anti-slipping member 52A, the eyeglasses 20 may be effectively prevented from falling away from the forehead 90B of the user 90. To the contrary, the eyeglasses 20 may be smoothly rotated upward even if the anti-slipping member 52A contacts the body surface of the user 90 when the front frame 21 of the eyeglasses 20 is lifted up. Further, examples of the fish skin having scales may be, but are not limited to, ray skin, shark skin and filefish skin. In particular, the ray skin and the shark skin may have placoid scales composed of layers of dentine and enameloid. The placoid scales may have increased strength and durability without any chemical treatment. Therefore, the ray skin and the shark skin may be preferably used as the anti-slipping member 52A.

Further, in these embodiments, the nose pad may be connected to the nose pad arm by inserting the engagement strip formed on the pad body into the nose pad attaching ring formed on the nose pad arm. However, the nose pad may be connected to the nose pad arm by inserting the engagement strip into a Y-shaped terminal formed on formed on the nose pad arm as an alternative to the nose pad attaching ring. Further, the nose pad may be connected to the nose pad arm using a box-shaped connecting member, which is a known connecting mechanism between the nose pad and the nose pad arm.

Further, in these embodiments, full rim eyeglasses may be exemplified as the eyeglasses 20 and 30. However, the eyeglasses 20 and 30 may be rimless eyeglasses (two-point eyeglasses) or other various types of eyeglasses. Further, eyeglasses with lenses, i.e., prescription eyeglasses, may be exemplified as the eyeglasses 20 and 30. However, the eyeglasses 20 and 30 may be non-prescription eyeglasses (e.g., a sunglass) or lensless eyeglasses.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A nose pad for eyeglasses configured to be attached to a front frame of the eyeglasses, comprising:
a pad body,
an extended portion formed on an upper portion of the pad body and configured to extend toward the front frame of the eyeglasses when the nose pad is attached to the front frame; and
an anti-slipping member formed on the extended portion.

2. The nose pad of claim 1, wherein the extended portion has a first surface facing the front frame of the eyeglasses and a second surface opposite to the first surface, and wherein the anti-slipping member is formed on the second surface of the extended portion.

3. The nose pad of claim 2, wherein the anti-slipping member comprises a sheet-like member made of a rubber material.

4. The nose pad of claim 2, wherein the anti-slipping member comprises a plurality of projections.

5. The nose pad of claim 2, wherein the anti-slipping member comprises a member having a plurality of projections.

6. The nose pad of claim 5, wherein the member having a plurality of projections comprises a fish skin having scales.

7. The nose pad of claim 1, wherein the anti-slipping member comprises a projection curved in a direction away from the front frame of the eyeglasses.

8. The nose pad of claim 7, wherein the projection is integrally formed as a portion of the extended portion.

9. Eyeglasses comprising:
a front frame;
a pair of temples; and
a nose pad attached to the front frame,
wherein the nose pad comprises a pad body, an extended portion formed on an upper portion of the pad body and configured to extend toward the front frame of the eyeglasses, and an anti-slipping member formed on the extended portion.

10. The nose pad of claim 9, wherein the extended portion has a first surface facing the front frame of the eyeglasses and a second surface opposite to the first surface, and wherein the anti-slipping member is formed on the second surface of the extended portion.

11. The nose pad of claim 9, wherein the anti-slipping member comprises a projection curved in a direction away from the front frame of the eyeglasses.
